(19) United States
(12) Patent Application Publication
(10) Pub. No.: US 2007/0279529 A1
(43) Pub. Date: Dec. 6, 2007

(54) Device and method utilizing a self-organizing visual analog representation of electronic media

(76) Inventors: Mark Buchanan, Santa Cruz, CA (US); Gaben Chancellor, Santa Cruz, CA (US); Alan Peevers, Santa Cruz, CA (US)

Correspondence Address: PATRICK REILLY, BOX 7218, SANTA CRUZ, CA, 95061-7218, US

(21) Appl. No.: 11/446,492

(22) Filed: Jun. 1, 2006

(51) Int. Cl. H04N 9/64

(52) U.S. Cl. 348/604

(57) ABSTRACT

A method and device for facilitating navigation of digital media to a user are provided. A digital media player, or (“client”) has access to a plurality of digital media records, e.g., a library of digitized musical performances that may be stored in a memory of the device. The client may have access to electronic digital media documents stored in additional devices or memories, and/or via an electronic communications network to a data warehouse. The client enables a user to select an electronic document for playing on the client from a plurality of electronic documents. The client presents two or more visual images to the user, wherein each visual image represents a discrete electronic digital document, e.g., a CD jewelcase or a DVD package. The software directs the user to select a visual image, in which the images that are subsequently presented to the user may depend upon previous user selections.

### FIELD OF THE INVENTION

The Present Invention relates to navigation within digital media documents associated with a digital electronics device. More particularly, the Present Invention relates to enabling a user to manage the selection and presentation of digital media documents by means of a digital electronics device.

### BACKGROUND OF THE INVENTION

Due to recent developments in digital media technology, consumers of electronic media have access to an unprecedented amount of digital media. Large volumes of digital media and multimedia can now be stored and viewed on various types of digital media players, such as personal computers, IPOD™ digital media players and other hand-held digital media players, cell phones, pocket personal computers, and other consumer electronic devices that are enabled as electronic digital media players. Yet the user experience in managing, selecting and retrieving digital media documents for presentation can be degraded by the very abundance of digital media documents that are stored within or made accessible to a digital media player. In the prior art the user can become victim to Draeger's effect, wherein a human being is overwhelmed by the number of choices of available and will often lose interest in making a selection.

The IPOD™ digital media player has been a success in part due to its simplistic and rather rigid organization of visually displayed text menus. The IPOD digital media player is currently available in models that store up to 60 gigabytes or more of information and can stored hundreds of music and video digital media documents, e.g., digital media files. Selections from the stored digital media documents are made from a pre-established hierarchy of categories wherein selections are made from textual identifiers of each digital media document. It is understood that the terms media document, digital media document, digital document, electronic document and document are defined herein as to include data, files, or machine-readable code that may be rendered by a computational engine to enable presentation of informational content to a user by means of a video display, video touch screen, audio output module, and/or other suitable output device known in the art, and wherein the informational content is at least partially encoded in the instant software program, file or machine-readable code. It is further understood that the informational content may be wholly or partially intended to provide entertainment, explanation and/or instruction. The computational engine and display device may be communicatively coupled together, or be comprised within a same electronic device, such as a personal computer, a digital media player, a personal digital assistant, a cellular telephone, or other suitable electronic device known in the art.

In other multimedia presentation environments, a digital media player has access to a computer-readable medium storing compressed media data documents, such as Moving Picture Experts Group audio layer-3 (MP3) documents and WINDOWS MEDIA technologies audio (WMA) documents. When the media documents are available for rendering on a digital media player, the player often has access to a database storing metadata that may describe albums, artists, genres, years, or the like for the digital media document. The player typically organizes the electronic media documents into a software structure based on metadata associated with the electronic documents. For example, in the case of music audio media documents, the electronic documents may be organized by album, artist, genre, year, or some user specified selection and ordering. This allows users to have an intuitive means of searching digital media player content regardless of whether or not the users manually created a hierarchical directory structure.

However, a playlist having a large number of electronic documents may be difficult for a low-powered device to navigate by the prior art. To obtain the metadata for the media files, certain existing systems have to open each electronic media document to obtain and display the metadata. Opening every electronic media document in a device may be slow and may increase system complexity. The prior art thereby creates a dilemma wherein the complexity of the user interface may degrade the quality of the user experience as a consequence of the user being offered access to increasing numbers of digital media documents.

There is therefore a long felt need to provide systems and techniques that increase the ease with which a user of a digital media player may peruse and select electronic documents for presentation on a digital media player.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the present invention. Rather, the sole purpose of this summary is to present some concepts of the invention in a simplified form as a prelude to the more detailed description that is presented hereinafter. The Method of the Present Invention provides a pi-con that is a visual representation of an image related to an electronic document, such as a pi-con comprising a visual representation of a CD album graphic that is associated with an electronic record of a vocal performance. A pi-con may be rendered for display by a client system, wherein the client system is provided with a digitally encoded machine-readable pi-con data that is comprise within or associated with an electronic document and from which pi-con date the client system renders the pi-con.

In a first preferred embodiment of the Method of the Present Invention a handheld digital media player includes a controller module, a display module and a memory containing a plurality of electronic documents. Each electronic document comprises a digital media wherefrom the display module may render text, graphics, animation, photographs, animation, sound and video for sensory perception by a user. Alternatively, optionally or additionally the digital media player may be coupled with one or more external libraries of electronic documents, sources of streaming digital media, and/or other digital media players. A second preferred embodiment of the Method of the Present Invention provides a user interface method for interacting with a digital media player. The digital media player may have (1.) a memory device storing a plurality of electronic documents, (2.) an audio output device, and (3.) a video screen for displaying a presentation of the plurality of electronic documents. The user interface method allows user to direct the device to (1.) associate each of the electronic documents with a unique and distinct pi-con; (2.) present at least two pi-cons to the user by means of the video screen; and (3.) enable the user to select at least one pi-con, whereby an electronic document associated with the selected pi-con is subsequently rendered as a user experience, or as part of a user experience, by the digital media player. Optionally, alternatively or additionally, the digital media player may be bi-directionally coupled with a streaming media source, and the method may further empower the user to select a pi-con associated with a streamed electronic document whereupon the streamed electronic document is rendered by means of the digital media player.

In certain alternate preferred embodiments of the Method of Present Invention, a first pi-con is presented in a first window of a video screen of digital media player. The user may scroll through a first plurality of pi-cons presented in the first window by means of the video screen and select one of the pi-cons presented in the first window, whereupon a document associated with a selected pi-con is subsequently rendered by the digital media player. One or more pi-cons may be associated with an electronic document, or information comprised within an electronic document, wherein the electronic document selected from the group consisting of a digitized photographic data document, a digitized video data document, a digitized animation data document, and a digitized audio data document. A pi-con is associated with a document when pi-con data used by the client system to render the pi-con is stored within, or accessible to, the client system, and the pi-con data is included within either the instant document or within a record that includes or is linked to the document.

In certain other alternate preferred embodiments of the Method of the Present Invention, the user may scroll through a second and/or third plurality of pi-cons presented respectively in a second window and/or third window, select one of the pi-cons presented in the second window or third window, whereupon an electronic document associated with the selected pi-con is subsequently rendered by the digital media player. In certain yet other alternate preferred embodiments of the Method of the Present Invention, at least one pi-con is a visual representation of the physical package associated with an associated electronic document. The at least one pi-con may substantively model the aspect ratio of the physical package. The pi-con may be designed and presented to reinforce a notion that the pi-con represents and shares many qualities with the physical object that the pi-con is associated with, e.g., wherein a pi-con is configured to create, instill, optimize, or support a psychological association on the part of the consumer between an electronic document and a physical product, such as a CD or a CD package, that is associated with both the pi-con and the instant electronic document. The pi-con may optionally, alternatively or additionally provide an image visually similar to, and/or modeling an aspect ratio of, a view of a marketing package of a CD or DVD product, e.g., a visual image presented on a jewel box case of a CD or a DVD product.

A first preferred embodiment of the Present Invention is a graphical user interface (hereafter, “GUI”) having two or more display regions, wherein each display region is separately reserved to visually present pi-cons or other information related to electronic documents having a particular shared theme, nature or quality, e.g., animation, music, video, photograph, and sub categories of these or other groupings of electronic documents. In one exemplary alternate preferred embodiment of the GUI, a first GUI region is reserved to present pi-cons and/or other information related to documents having video and audio content, a second GUI region is reserved to present pi-cons and/or other information related to documents having music and/or video content, and a third GUI region is reserved to present pi-cons and/or other information related to documents having photographic and/or audio content.

In certain still alternate preferred embodiments of the GUI and in accordance with the Method of the Present Invention, the GUI is displayed on a video display device of a client system. The terms client and client system are synonymous as used in this disclosure and are defined herein to include electronic devices configured to render digital media documents. Certain preferred alternate embodiments of a client or client system may comprise a display module, a memory module for electronically storing electronic documents in whole or in part, and a computational engine for rendering electronic documents by means of the display module.

An exemplary client system, mentioned as an example only and not as limiting the scope of the Present Invention as claimed, includes a (1.) controller module as a computational engine, (2.) an electronic memory configured to store electronic documents, (3.) a display module including a video display device and an audio output device, (4.) a data input module configured to receive electronic data streams, uploads and/or downloads of electronic documents, and/or (5.) a user control module. The video display may optionally be or include a touch screen to provide tactilely generated input from a user to the controller module.

At least a first region of the GUI displays a first information, pi-con or image associated with a first electronic document of a first plurality of electronic documents, and a second region displays a second information, image or pi-con associated with a second plurality of electronic documents. A user may select the first image to direct the client system a render the first electronic document, or the second image to explore the second plurality of electronic documents.

Certain alternate preferred embodiments of the GUI includes a third region for rendering a third image, where the third image is associated with a third electronic document of a third plurality of electronic documents.

Certain yet other alternate preferred embodiments of the Method of the Present Invention provide an article of manufacture that includes a sequence of instructions which, when executed by a processor, causes the processor to generate a GUI. The GUI may render or include a first region for displaying a first image associated with a first electronic document of a first plurality of electronic documents, a second region for displaying a second image associated with a second electronic document of a second plurality of electronic documents, and/or a third region for displaying a third image associated with a third electronic document of a third plurality of electronic documents. A user may select the first image to render the first electronic document, or the second or third images to explore the second or third plurality of electronic documents.

Other alternate preferred embodiments of the Present Invention are one or more computer-readable media including a sequence of computer-readable instructions which, when executed by a processor, causes the processor to generate a GUI. The GUI may render or include a first region for displaying a first image associated with a first electronic document of a first plurality of electronic documents, a second region for displaying a second image associated with a second electronic document of a second plurality of electronic documents, and/or a third region for displaying a third image associated with a third electronic document of a third plurality of electronic documents. A user may select the first image to render the first electronic document, or the second or third images to explore the second or third plurality of electronic documents.

Still other alternate preferred embodiments of the Present Invention provide a hand-held device having a central processing unit and means to render a GUI. The central processing unit is coupled with a video display and a memory unit, wherein the central processing unit renders to the video display a plurality of electronic documents. The means to render a GUI presents a plurality of images on the video display, wherein each of the images represents one of the electronic documents.

The term digital media as defined herein refers to digitally encoded computer-readable representations of text, graphics, animation, photographs, animation, sound and/or video.

The term digital media player is defined herein to include an electronic device that can read a digital media document from a digital storage media, render the digital media document, and provide an audio and/or visual output to a user that comprises at least some of the rendering of the digital media document.

The terms digital media document, electronic media document, and electronic documents are synonymous as used in this disclosure and are defined herein to include digitized information that is formatted and organized to be rendered by a digital media player to provide an audio and/or visual presentation to a user of the digital media player.

The term pi-con is defined herein to represent a visual image that is associated with at least one electronic document. A pi-con may be an image that has dual or multiple uses in the identification, marketing, advertising, distribution, presentation and selection of an associated electronic document. A pi-con data is a machine readable software encoded information that enables a suitably configured information technology system to render and visually render a pi-con.

These and other aspects, features and advantages of the present disclosure will become apparent from the following description of exemplary embodiments, which is to be read in connection with the accompanying drawings.

### BRIEF DESCRIPTION OF THE DRAWINGS

The invention of the present application will now be described in more detail with reference to the accompanying drawings, given only by way of example, in which:

FIG. 1 is an illustration of a front side of a client system;

FIG. 2 is a schematic representation of an information technology network coupled with the client system of FIG. 1;

FIG. 3 is a schematic diagram of the client system of FIG. 1;

FIG. 4 is a state diagram of the client system of FIG. 1;

FIG. 5 is a representation of an electronic document formatted for storage and/or rendering by the client system of FIG. 1;

FIG. 6 is a representation of a plurality of electronic documents of FIG. 5 as stored in records within a memory of the client system of FIG. 1;

FIG. 7 is a schematic of a data structure maintained by the client system of FIG. 2, wherein the instant data structure comprises a plurality of electronic documents formatted in accordance with the FIG. 5 and stored in records formatted in accordance with FIG. 6;

FIG. 8 is a detailed schematic of a portion of the data structure of FIG. 7;

FIG. 9 is a representation of a look-up table used to associate the electronic documents of FIGS. 5 and 6 with the menu of FIG. 4;

FIGS. 10A and 10B comprise a flowchart of the operation of the GUI instantiated by the client system of FIG. 1; and

FIG. 11 is a flowchart of an optional or additional process of the flowchart of FIGS. 10A and 10B.

### DETAILED DESCRIPTION OF A PREFERRED EMBODIMENT

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

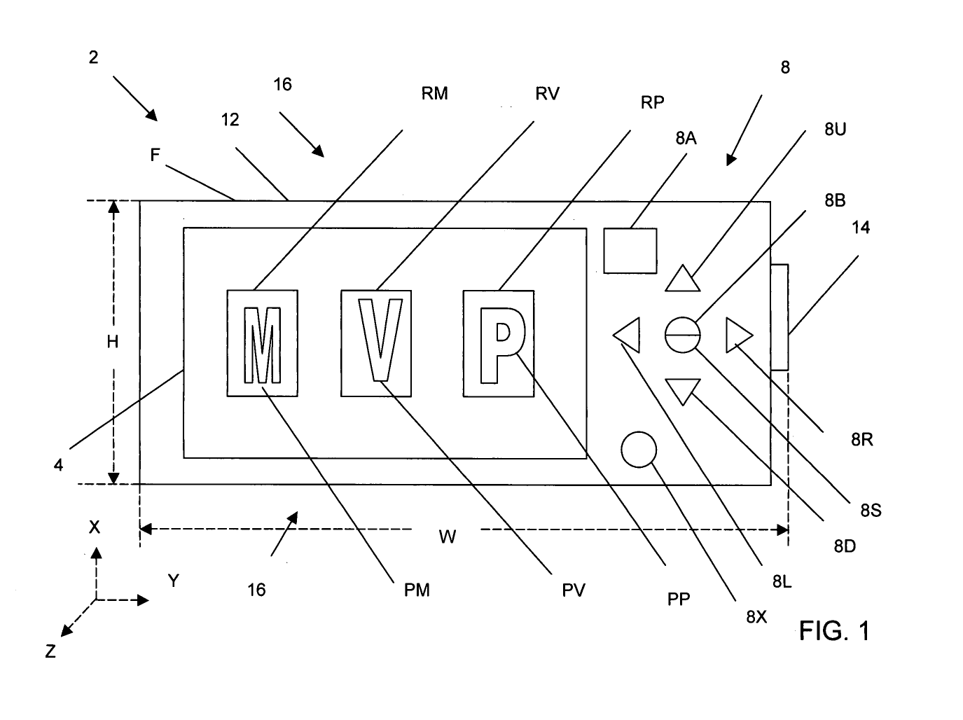

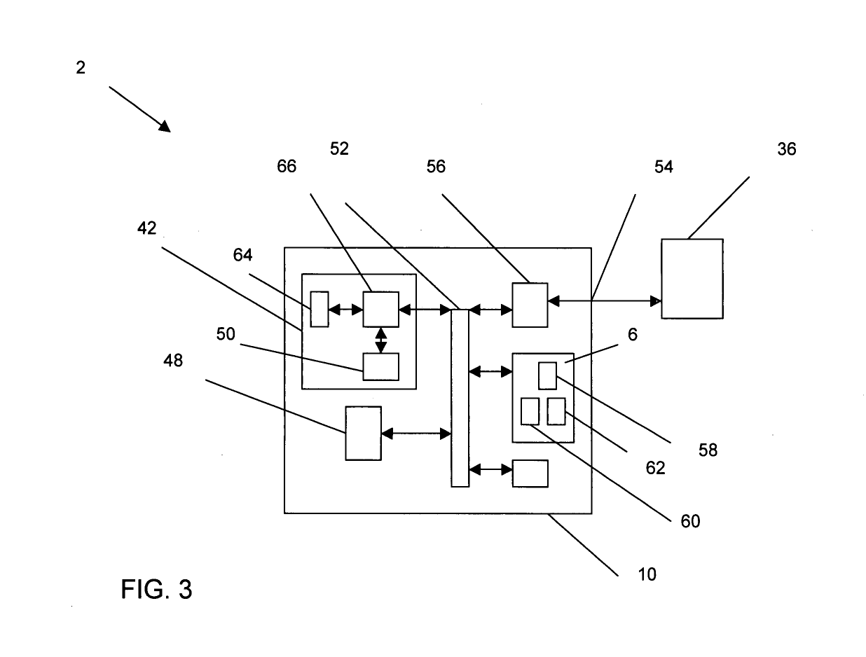

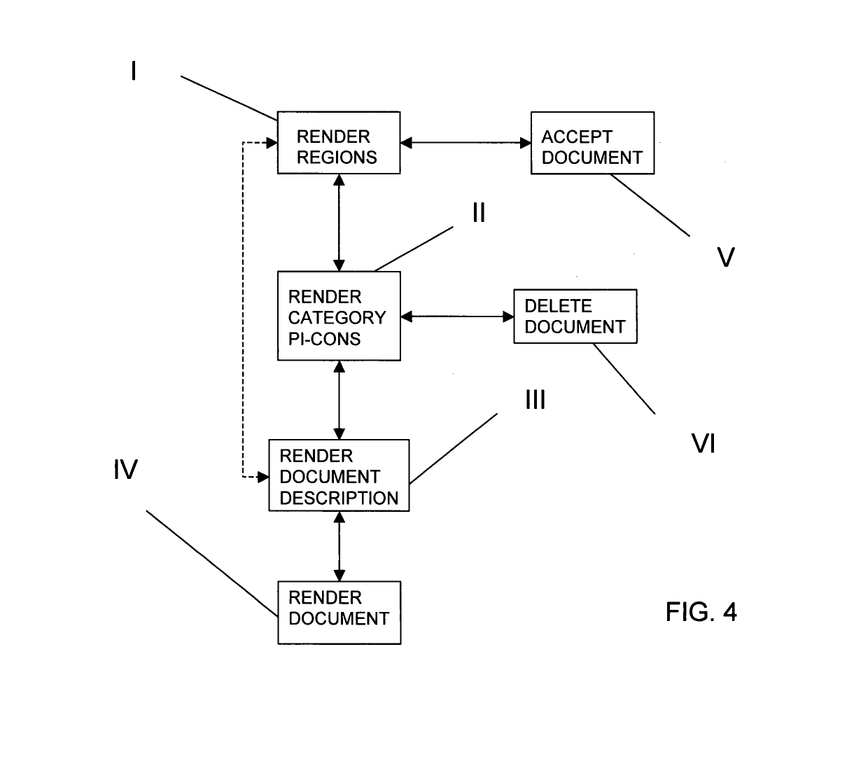

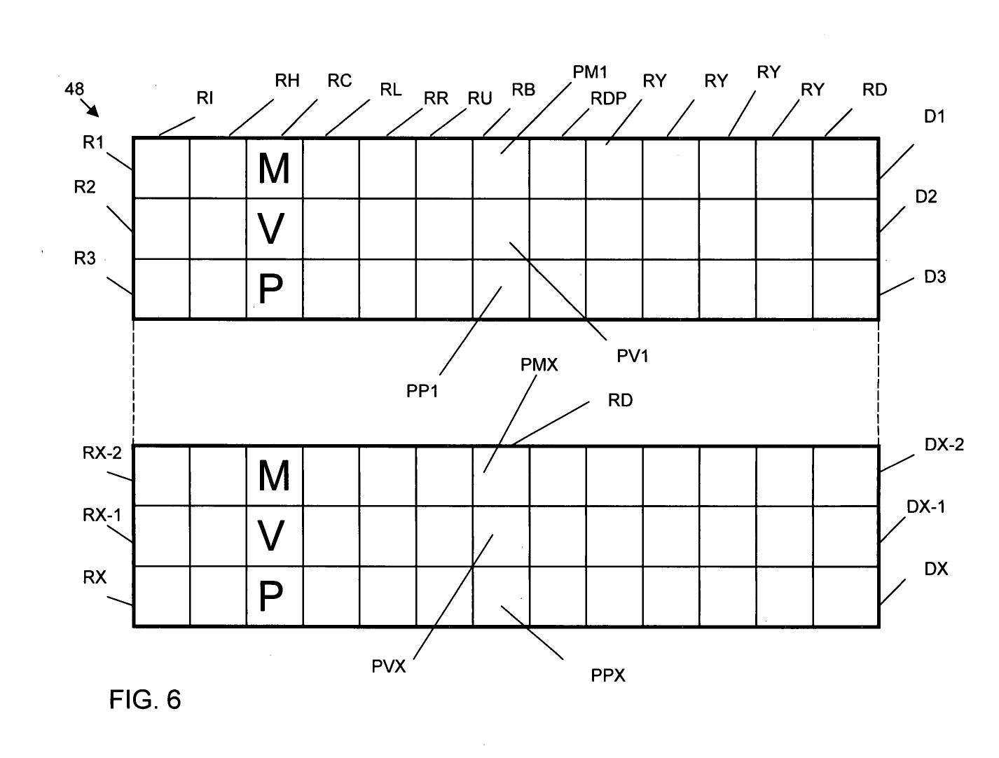

Referring now generally to the Figures and particularly to FIG. 1, FIG. 1 is an illustration of a front face F of a client system 2 wherein a display screen 4 of a display module 6 (as per FIG. 3) and a plurality of input controls 8 of a user control module 10 (as per FIG. 3) are presented. The client system 2 includes a housing 12, and the housing 12 and the entire client system 2 are sized to fit within an shape of three inches in height H along an X axis, five inches of width W along an X axis, and one half inch of depth along a Z axis, wherein the X, Y and Z axis are three mutually orthogonal axes. An interface fixture 14 enables the client system 2 to communicatively couple with one or more external sources of digital media documents D1-DX, as discussed below in reference to FIG. 6. An interface accept control button 8A of the user controls 8 directs the client system 2 to receive one or more digital media documents D1-DX as further discussed below in reference to FIG. 4. An interface delete control button 8X of the user controls 8 directs the client system 2 to delete a digital media documents D1-DX as further discussed below in reference to FIG. 4.

A graphical user interface software stored in the client system 2 (hereafter “GUI 16”) directs the client system 2 to define three separate regions RM, RV & RP within the display screen 4, wherein pi-cons PM, PV & PP are each individually visually displayed in one selected region RM, RV & RP. Each region RM, RV & RP displays only one pi-con P1-PX at a time. The pi-cons P1-PX include music content pi-cons PM1-PMX associated music content documents DM1-DMX, video content pi-cons PV1-PVX associated with video content documents DV1-DVX, and photographic content pi-cons PP1-PPX associated with video content documents DP1-DPX, as illustrated in FIG. 6.

A first region RM presents a pi-con PM selected from pi-cons PM1-PMX associated with digital music data electronic documents DM1-DMX, a second region RV displays a pi-con PV selected from pi-cons PV1-PVX associated with digital video data electronic documents DV1-DVX, and a third region RP displays a pi-con PP selected from pi-cons PP1-PPX associated with digital photograph electronic documents DP1-DPX. The designations D1-DX as used herein comprise the music content documents DM1-DMX, the video content document DV1-DVX, and the photographic content documents DP1-DPX.

It is understood that an electronic document D1-DX may optionally contain data of more than one type, e.g., where a document DM1 is stored and categorized by the client system 2 as a music document DM1, but comprises a music video having both audio and video content. Where only one electronic document D1-DX of any three categories of electronic documents, i.e., video, photographic and audio, is available the pi-con P1-PX for that one document may be displayed in the associated region RM, RV or RP. In certain alternate preferred embodiments of the Method of the Present Invention, the client system 2 may categorize a document D1-DX according to an indicator information provided in or associated with the instant document, and in certain still other alternate preferred embodiments of the Method of the Present Invention the client system may assign a category, e.g., music, video, animation, photograph, to a document D1-DX in accordance with a criteria stored within or accessible to the client system 2, e.g. by file extension or file header information provided in association with the instant document D1-DX. Alternatively, the user may be enabled by the client system 2 to designate a document to one or more categories as organized within the client system 2.

The manual input controls 8 include the document accept control 8A, the document deletion button 8X, a select button 8S, a return navigation button 8B, an up menu navigation button 8U, a down menu navigation button 8D, a right menu navigation button 8R, and a left menu navigation button 8L. In operation, the user may hold the client system 2 in a palm of one hand, while paging through and selecting from pi-cons P1-PX presented on the display screen 4 by means of the input controls. The user depresses a manual control 8 to issue a related command to the client system 2. For example, depressing the select button 8S with four or more ounces of pressure, where depression is accomplished by pushing the instant manual control 8 along the Z axis towards a center plane of the client system 2, initiates a signal to a controller module 16 (as per FIG. 3), that a document D1-DX associated with an indicated pi-con P1-PX is to be rendered, i.e., played, by the client system 2. The user may alternatively depress the navigation button 8B to return to the most previous focus and state of the GUI 16. The right menu navigation button 8R is used to command the client system 2 to change the indicated region RM, RV or RP from (1.) RM to RV, (2.) RV to RP, or (3.) RP to RM. The left menu navigation button 8L is used to command the client system 2 to change the indicated region RM, RV or RP from (1.) RP to RV, (2.) RV to RM, or (3.) RM to RP. The up menu navigation button 8U is used to direct the client system 2 upwards within a menu or other suitable selection structure known in the art, and the down menu navigation button 8D is used to direct the client system 2 downwards or alternate direction within a menu or other suitable selection structure known in the art.

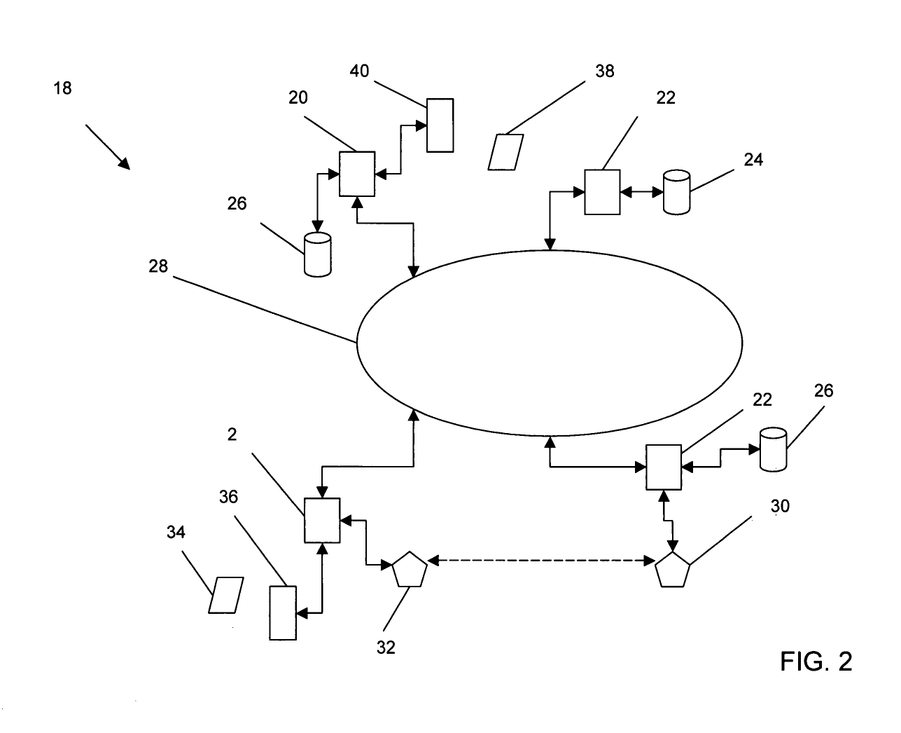

Referring now generally to the Figures and particularly to FIG. 2, FIG. 2 is a schematic representation of an information technology network 18 coupled with the client system 2 of FIG. 1. The client system 2 (hereafter “client”) may accept electronic documents D1-DX from one or more additional clients 20 that are also coupled with the information technology network 18. The client 2 may optionally, alternatively or additionally receive electronic documents D1-DX from one or more servers 22 hosting electronic document storage system 24 and/or one or more streaming media repositories 26. The user directs the client system 2 to accept a document by streaming, upload or download by depressing the interface accept control button when the instant document is available for streaming, download or upload.

The information technology network may further comprise the Internet 28 and a wireless transponder 30. The wireless transponder 30 may, in certain still other alternate preferred embodiments of the Method of the Present Invention, transmit by streaming or a download one or more electronic documents D1-DX to the client system 2 via a wireless receiver 32. The wireless receiver 32 is communicatively coupled with the client system 2 to provide an alternate, optional or additional communications pathway for the client system 2 to receive documents D1-DX via the Internet 28.

Documents D1-DX may further be provided to the client system 2, in certain yet other preferred embodiments of the Present Invention, from a media storage device 34 and via a media reader 36. In one exemplary version of the Present Invention, the media storage device 34 may be a DVD and the media reader 36 may be a DVD player configured to read a document D1-DX from the media storage device 34 and transfer an electronic copy of the selected document D1-DX to the client system 2. In an alternate exemplary version of the Present Invention, a remote media reader 40 may be communicatively coupled with the additional client system 20 or the server 22. The remote media reader 40 may be a DVD player configured to read a document D1-DX from the media storage device 34 and transfer an electronic copy of the selected document D1-DX to the client system 2 via (1.) the server 22 or the additional client 20, and (2.) the Internet 28. Alternatively or additionally, the media storage device 34 may be a smart card housing an electronic memory containing one or more electronic documents D1-DX, and the media reader 36 may be configured to (1.) generate a copy of the instant electronic document D1-DX stored on the smart card, and (2.) provide a copy of the instant electronic document D1-DX to the client system 2.

Referring now generally to the Figures and particularly to FIG. 3, FIG. 3 is a schematic of a client system 2 having a controller module 42, the display module 6, the user control module 10 and a memory 48. The main memory 48 and an optional cache memory 50 of the controller module 42 may be used to store a plurality of electronic documents D1-DX. The cache memory 50 may be used to temporarily store and provide information to the display or controller module, wherein the information stored in the cache memory 50 may be or include information of, or related to a pi-con P1-PX, streamed data, and/or downloaded data. The user control module 10 includes the manual input controls 8S, 8B, 8A, 8U, 8D, 8R & 8L and enables a user to transmits commands to select for rendering, delete, add and/or organize electronic documents D1-DX. The user control module 10 communicatively couples the input controls 8 with the controller module 42 via the communications bus 52 whereby instructions from the user are communicated by means of user activation of the input controls 8S, 8B, 8A 8U, 8D, 8L & 8R, e.g., by manual manipulation or optionally voice activation. The user control module 10 translates the user's activation into electronically formatted commands that may be read by the controller module 42 to select for rendering, delete, add, and/or organize one or more electronic documents D1-DX.

An internal communications bus 52 communicatively couples the controller module 42, the display module 6, the user control module 10 and the memory 48. The optional media reader 36 may be coupled with the communications bus 52 via a signal pathway 54 and a communications interface device 56, and may thereby provide electronic documents D1-DX that are readable and renderable by the client system 2. Alternatively, optionally or additionally, the signal pathway 54 may communicatively couple the client 2 to the communications network 18, whereby the client system 2 may accept streaming media transmissions and/or downloads from one or more digital media devices 20, 22, digital media reader 40, and/or remote media devices 38. The media reader 36 may alternatively, optionally or additionally be configured to read electronic documents D1-DX from FLASH memory or other suitable digital memory devices known in the art.

The display module 6 includes an audio output circuit 58 and optionally a video display device 60. It is understood that certain yet other alternate embodiments of the Present Invention the display module 6 may additionally or alternatively be or include a touch screen 62, wherein the touch screen 62 is used by the display module 6 to (1.) visually present images rendered from one or more electronic documents D1-DX, and (2.) detect physical pressure against the touch screen 62. These physical pressure detections are communicated to the controller module 6 and/or the user control module 10 for consideration and interpretation as user directions.

The optional communications interface device 56 may be configured to communicatively couple the client system 2 via the signal pathway 54 with the information technology network 18 that may include an electronic communications network, a computer network, an telephony network, and/or a wireless electronic communications network. The communications interface device 56 is coupled with the internal communications bus 52 and may additionally and optionally be configured to accept streaming media information and enable the client to render the streaming media or downloaded information.

The controller module 42 includes a firmware 64 and a processor 66 for directing the operations of the client 2. The firmware 64, cache memory 50 and the processor 66 are configured to enable the execution, in combination with the memory 48 and the remainder of the client 2, the operational steps described herein.

Referring now generally to the Figures and particularly to FIG. 4, FIG. 4 is a state diagram of six primary modalities of the client system 2 and the GUI 16. In a first state I the client system is rendering one pi-con P1-PX in each region RM, RV & RP, wherein each pi-con P1-PX displayed in the first state I is selected from a separated subset PM1-PMX, PV1-PVX, & PP1-PPX of the pi-cons P1-PX that is individually associated with a unique region RM, RV or RP. The client system may be driven from the first state and into the second state by the user pressing the select button 8S when a region RM, RV, RP is presenting a pi-con P1-PX that is simultaneously under focus. The pi-con P1-PX under focus may be highlighted or otherwise visually indicated on the display screen 4 to be under focus.

In the second state II the client system renders two or more of the subset of pi-cons P1-PX associated with the region RM, RV, or RP selected during the most recent instantiation of the first state I. The pi-cons P1-PX rendered in the second state II may be visually presented as a linear listing or series, or as individual two-dimensional tiles T1-TX located within a mosaic M of tiles T1-TX, as per FIG. 12. The mosaic M of tiles T1-TX may display-a pi-con P1-PX as a two-dimensional image, and the second state may enable navigation among the mosaic M by shifting the focus from one tile T1-TX to another tile T1-TX by means of the navigation buttons 8U, 8D, 8L & 8R. The dimensions of each tile T1-TX may have a minimum magnitude of display distance, e.g., each tile T1-TX may have a minimum are of display of the display screen 4 of 0.5 centimeters by 0.5 centimeters. When the display area of the display screen 4 is too small to simultaneously display all of the pi-cons P1-PX of the category selected for display in the second state, the mosaic M may organize one or more tiles T1-TX to be “off screen” but accessed by means of the navigation buttons 8U, 8D, 8L & 8R. The user drives the client system 2 from the second state II to a third state III by means of pressing the select button 8S when a pi-con P1-PX displayed during actualization of the second state II is under focus.

In the third state III, descriptive information relating to, and/or contained within, the document D1-DX associated with the pi-con P1-PX selected in the most recent instantiation of the second state II is rendered on the display screen. The user may the direct client system 2 to render the instant document D1-DX by pressing the select button 8s, whereupon the GUI 16 actualizes a fourth state IV, wherein the document selected in the third state III is rendered.

The user may user press the return navigation button to transition the client system 2 within the possible states, e.g., from the fourth state IV to the third state III, from the third state III to the second state II, and from the second state II to the first state I.

The user may, in certain additional other alternate preferred embodiments of the Method of the Present Invention, direct the client system 2 to transition from the first state I to a fifth state V wherein the user may direct the client system 2 to (1.) render a streamed document, and/or (2.) download, upload, and or store a document.

The user may further optionally in certain yet other alternate preferred embodiments of the Method of the Present Invention direct the client system 2 to transition from the second state II to a sixth state VI, wherein the user may direct the client system 2 delete a document D1-DX from the memory 48. A deletion command may be communicated by the user and to the client system 2 by the user depressing an optional deletion button 8X, whereupon the document D1-DX associated with the pi-con P1-PX last focused upon in the most recent actualization of the second state II will be deleted from the client system 2.

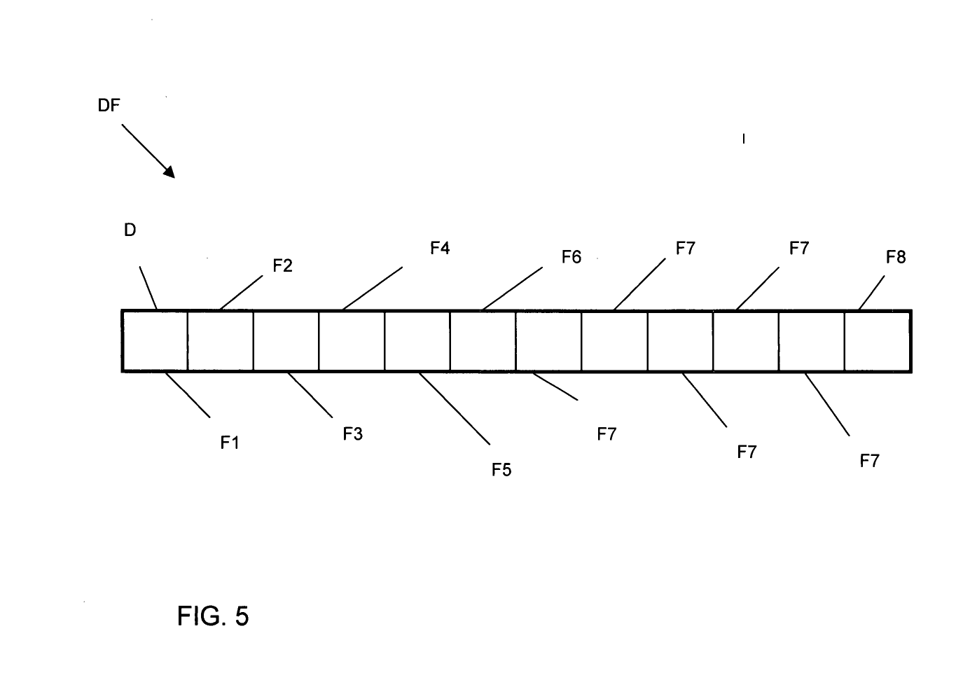

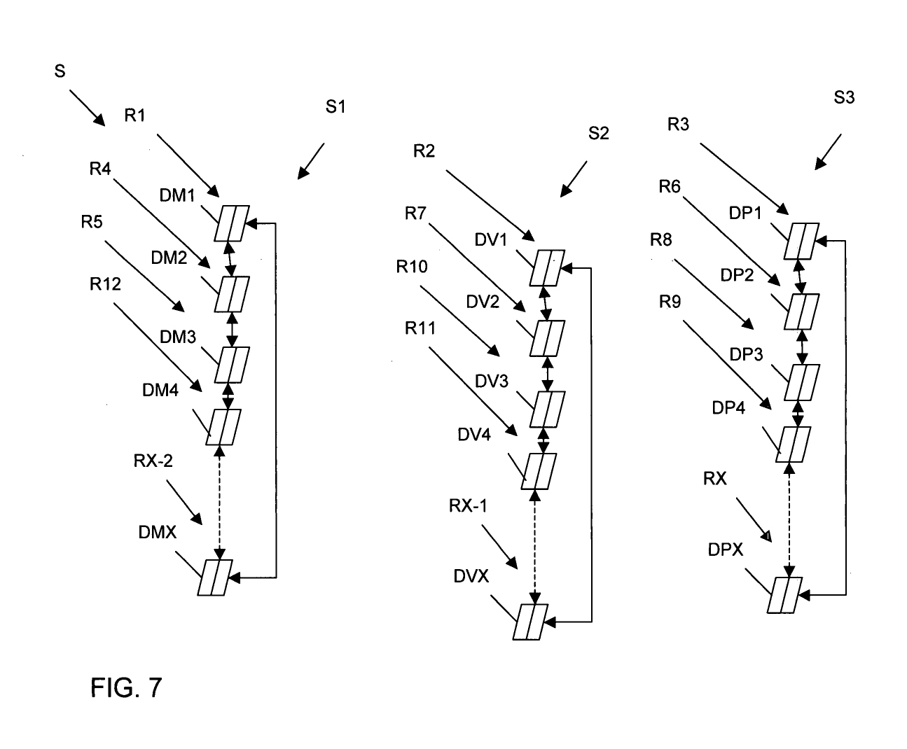

Referring now generally to the Figures and particularly to FIG. 5, FIG. 5 is a diagram of an electronic document format DF of a document D1-DX. It is understood that the plurality of documents D1-DX is a superset that includes the plurality of music documents DM1-DMX, the plurality of video documents DV1-DVX, and the plurality of photographic documents DP1-DPX, as discussed generally herein and particularly in reference below to FIGS. 6, 7, & 8.

The format includes data fields F1-F8 that include a header field F1, a document identifier field F2, a title field F3, a pi-con data field F4, a qualities field F5, a content field F6, optional fields F7 and a tail field F8.

A pi-con data stored in the pi-con data field F4 is used by the client system 2 to render a pi-con P1-PX related to the instant document D1-DX, and the stored pi-con data may be or comprise software that may enable the client system to render a music document pi-con PM1-PMX, a video document pi-con PV1-PVX, or a photographic document pi-con PP1-PPX, as illustrated in FIG. 6.

The header field F1 and tail field F8 include information used in the communication and processing of the document D1-DX, such as a sender and addressee identifiers, protocol identification and checksums. The document identifier field F2 contains a serial number associated with the document D1-DX. The title field F3 contains a textual representation of a title associated with the document D1-DX. The pi-con field F4 contains a pi-con data, i.e., a software-encoded representation of a pi-con P1-PX associated with a same document D1-DX. In particular the pi-con data, e.g. a bitmap, used to generate the categorized pi-cons PM1-PMX, PV1-PVX & PP1-PPX are stored in the pi-con data field F4.

The qualities field F5 is a metadata field that contains descriptive information useful in relating the document D1-DX within the software structure S. For example, the qualities field F5 may contain information indicating that a document D1-DX is video and is classed as a comedy, a documentary, or a drama. The content field F6 contains the information that will be rendered by the client system 2 to provide an educational or entertainment experience. The optional field F7 is available to transfer additional information, such as licensing permissions and use prohibitions.

Referring now generally to the Figures and particularly to FIG. 6, FIG. 6 is a representation of the storage of the plurality of documents D1-DX in the memory 48. The plurality of documents D1-DX is a superset that includes the plurality of music documents DM1-DMX, the plurality of video documents DV1-DVX, and the plurality of photographic documents DP1-DPX. Each record R1-RX includes data fields that respectively contain a single document D1-DX in a document field RD and a category assignment in a category assignment RC, e.g., music, video, photographic or animation. The instant document D1-DX stored in the document field RD may be a music document DM1-DMX, a video document DV1-DVX, or a photographic document DP1-DPX. The pi-con data used by the client system 2 to render the categorized pi-cons PM1-PMX, PV1-PVX & PP1-PPX are stored within the document F4 data fields that are included with the document D1-DX as stored in the document data field RD. Addresses of the records R1-RX storing documents of the same category as the instant record R1-RX may be stored in the record address data fields RL, RR, RU & RB.

The documents D1-DX are linked together by means of the records R1-RX in one-dimensional circular series. For example, the subset of video documents DV1-DVX are stored in selected records R1-RX, wherein each record R1-RX storing a video category document DV1-DVX identifies a memory address of a previous record R1-RX and a memory address of a next record R1-RX. The address of the previous record R1-RX is stored in the previous (or left) address data field RL, and the address of the next (or right) record is stored in the next address data field RR. Where the GUI 16 has organized a simultaneous display of a plurality pi-cons P1-PX on the display screen 4 in a mosaic M as per FIG. 12, the memory address of record R1-RX storing the pi-con P1-PX displayed above the pi-con P1-PX of the instant record R1-RX is stored in the up address data field RU, and the memory address of the record R1-RX storing the pi-con P1-PX displayed below the pi-con P1-PX of the instant record is stored in the down address data field RB. Alternatively some or all of the plurality of records R1-RX may be organized as a linked list wherein each record R1-RX is associated within the linked list to embody a two dimensional linked list.

The record address data fields RL, RR, RU & RB are thus used by the GUI 16 to coordinate the display and navigation among the pi-cons P1-PX. More particularly, as the user manipulates the navigation buttons 8U, 8D, 8L & 8R to transfer focus from one displayed pi-con P1-PX to another neighboring displayed pi-con P1-PX, the record address data fields RL, RR, RU & RB enable the GUI to display pi-cons P1-PX and interpret user commands in the second state II.

A record identifier is stored in each record ID field RI of each record R1-RX. Additional information may be stored in one or more auxiliary field(s) RY.

Referring now generally to the Figures and particularly to FIG. 7, FIG. 7 is a schematic of a data structure S maintained by the client system 2 of FIG. 2, wherein the instant data structure S comprises a plurality of electronic documents D1-DX formatted and stored both in accordance with FIG. 5 and stored in records R1-RX as formatted in accordance with FIG. 6. The data structure S comprises an S1 series of records R1, R4, R5, R12 & RX-2 (hereafter “S1 records”) that each store one unique music document DM1-DMX. The S1 records are linked in a one-dimensional circular series, wherein (1.) an address or pointer stored in the previous record data field RL of each S1 record point to a single preceding S1 record, and (2.) an address or pointer stored in the next record field RR of each S1 record point to a single following S1 record.

Similarly, an S2 series of records R2, R7, R10, R11 & RX-1 (hereafter, “S2 records”) each store one unique video document DV1-DVX. The S2 records are also linked in a one-dimensional circular series, wherein (1.) an address or pointer stored in the previous record data field RL of each S2 record point to a single preceding S2 record, and (2.) an address or pointer stored in the next record data field RR of each S2 record point to a single following S2 record.

Correspondingly, an S3 series of records R3, R6, R8, R9 & RX (hereafter, “S3 records”) each store one unique photographic document DV1-DVX. The S2 records are also linked in a one-dimensional circular series, wherein (1.) an address or pointer stored in the previous record data field RL of each S3 record point to a single preceding S3 record, and (2.) an address or pointer stored in the next record data filed RR of each S3 record point to a single following S3 record.

It is understood that the circular series S1, S2 and/or S3 may provide branches or sub-branches wherein one or more pluralities of documents D1-DX are organized and linked to the circular series S1, S2 and/or S3 as record R1-RX of the circular series S1, S2, and/or S3, or by other suitable branching and sub-branching data structures and techniques known in the art.

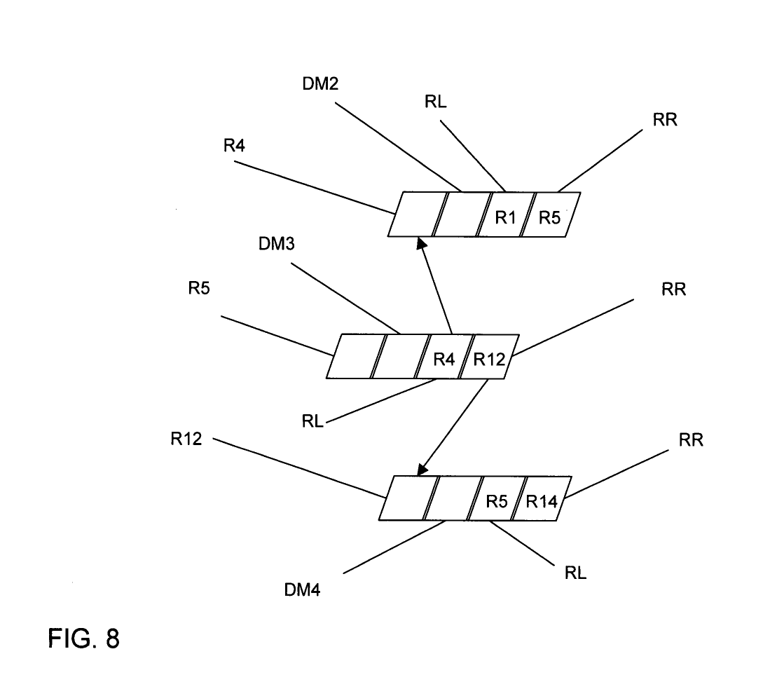

Referring now generally to the Figures and particularly to FIG. 8, FIG. 8 is a detailed schematic of a portion of the S1 series of records of the data structure S of FIG. 7. The second music document DM2 is stored in the fourth record R4, and a pointer to or address of the fifth record R5 is stored in the next record data field RR of the fourth record. It is understood that machine-readable code that enables the client system 2 to render the second music pi-con PM2 is stored in the second music document DM2 and therefore within the fourth record R4. It is further understood that (1.) machine-readable code that enables the client system 2 to render the third music pi-con PM3 is stored in the third music document DM3 and therefore within the fifth record R5, and (2.) that the machine-readable code that enables the client system 2 to render the fourth music pi-con PM4 is stored in the fourth music document DM4 and therefore within the twelfth record R12. Correspondingly, the third music document DM3 is stored in the fifth record R5, and a pointer to or address of the fourth record R4 is stored in the previous record data field RL of the fifth record R5. The fifth record R5 additionally stores a pointer or address to twelfth record R12 in the next record data field RR of the fifth record R5. By these pointers and/or addresses the S1 series of records maintains a one-dimensional circular order, whereby the user may page through the S1 series by means of the right navigation button 8R and the left navigation button 8L. In one exemplary alternate preferred embodiment of the Method of the Present Invention, when the third music pi-con MP3 is being rendered, the user may direct the client system 2 to render (1.) the second music pi-con MP2 by pressing the left navigation button 8L, or (2.) the fourth music pi-con MP4 by pressing the right navigation button 8R.

The first record R1 contains a pointer to or address of the record RX-2 (that stores the highest ordered music document DMX) in the previous record data field RL of the last record R1, and the record RX-2 correspondingly contains a pointer to or address of the last music document DMX in the next record data field RR of the record RX-2, whereby the one-dimensional circularity of the first series of records S1 is maintained.

The second series S2 storing video documents DV1-DVX and the third series S3 storing photographic documents DP1-DPX are structured and linked with the same schema as described above regarding the first series S1.

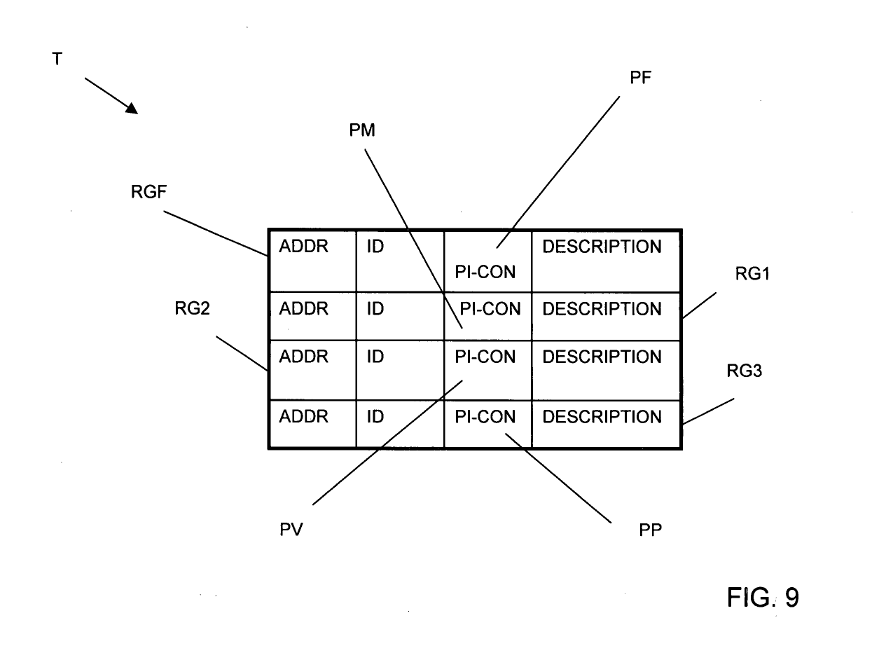

Referring now generally to the Figures and particularly to FIG. 9, FIG. 9 is a representation of a look-up table T maintained in the memory 48 and/or the cache memory 50. A focus register RGF maintains the address, pi-con data and ID of the document D1-DX storing the pi-con P1-PX presently under focus. As the focus shifts, the client system 2 updates the focus register RGF with memory address, pi-con P1-PX, and ID of the newly selected pi-on P1-PX.

A first region register RG1 of the table T stores the address, ID, pi-con data, and descriptive information (as per the third state III of FIG. 4) of the music document DM1-DMX storing the pi-con P1-PX most recently displayed in the first region RM. The pi-con data stored in the first register RG 1 enables the client system 2 to render pi-con PM of FIG. 1 in the first region RM of the display screen 4.

A second region register RG2 of the table T stores the address, ID, pi-con data, and descriptive information (as per the third state III of FIG. 4) of the document D1-DX storing the pi-con P1-PX most recently displayed in the second region RV. The pi-con data stored in the second register RG2 enables the client system 2 to render pi-con PV of FIG. 1 in the second region RV of the display screen 4.

A third region register RG3 of the table T stores the address, ID, pi-con data ID, and descriptive information (as per the third state III of FIG. 4) of the document D1-DX storing the pi-con P1-PX most recently displayed in the third region RP. The pi-con data stored in the third register RG3 enables the client system 2 to render pi-con PP of FIG. 1 in the third region RV of the display screen 4.

The table T thereby provides the GUI 16 with updated information that identifies which pi-con P1-PX is under focus, and which pi-cons P1-PX are to be displayed at the current or next rendering of the regions RM, RV, and RP in the second state II, and the presentation of information in the third state III.

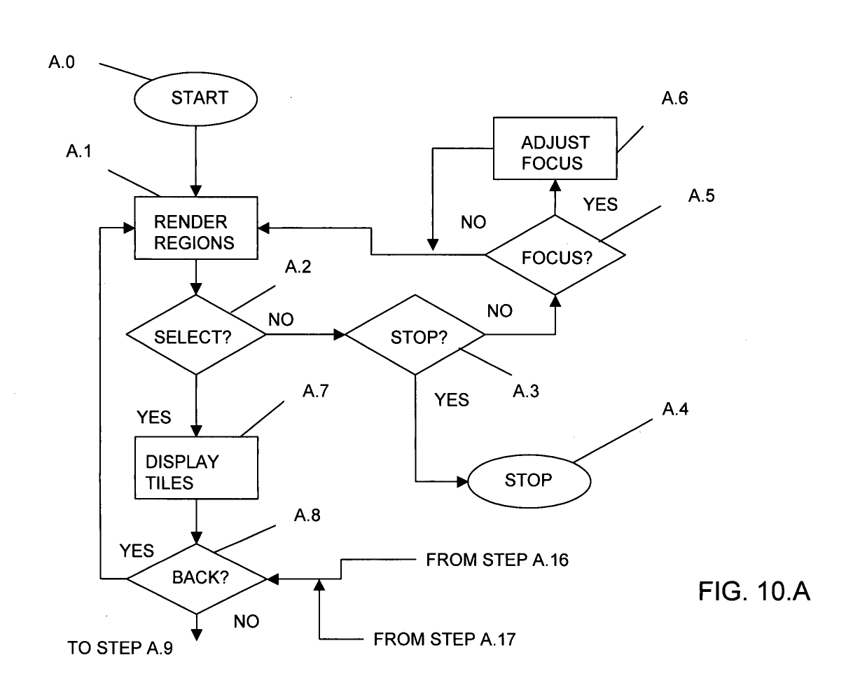

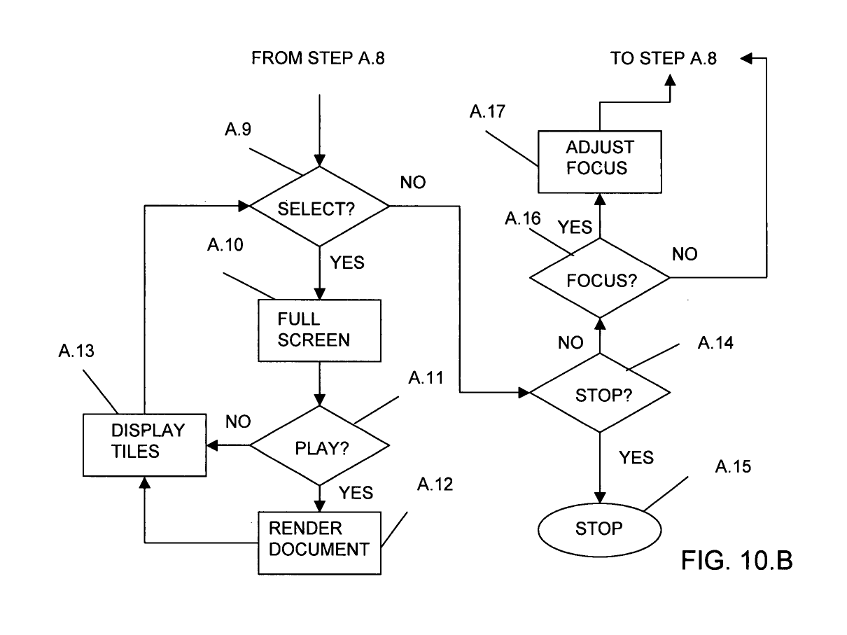

Referring now generally to the Figures and particularly to FIGS. 10A and 10B, FIGS. 10A and 10B comprise a flowchart of the operation of the GUI 16 instantiated by the client system 2 of FIG. 1. In step A.1 the client system initiates the first state I and renders the regions RM, RV & RP each displaying a corresponding pi-con PM, PV, or PP. In step A.2 the user may direct the client system to proceed on to the second state II by pressing the select button 8S. If no select command is received by the client system within 0.5 seconds, the client system 2 will proceed on to step A.3 to determine whether a stop command has been sent by the user. If a stop command has been sent by the user's simultaneously depressing the select button 8S and the return navigation button 8B for longer than two seconds, the client system 2 will proceed on to step A.3 and power down the client system 2 in step A.4. It is understood that the user may interrupt system operation and turn off the client system 2 by simultaneously depressing the select button 8S and the return navigation button 8B for longer than two seconds generally during client system 2 operation.

In step A.5, the client system 2 determines whether the user has issued a command to shift focus from one region RM, RV & RP by depressing the right navigation button 8R or the left navigation button. Pressing the right navigation button 8R directs the client system 2 to shift focus, and update the focus register FR of the table T, from PM to PV, from PV to PP, or from PP to PM. Alternatively, pressing the left navigation button 8L directs the client system 2 to shift focus, and update the focus register FR of the table T, from PM to PP, from PP to PV, or from PV to PM. In step A.6 the client system shifts focus and updates the focus register FR.

In step A.7 the client system actualizes the second state II and presents a plurality of pi-cons P1-PX in the display screen 4, either as a list, or a tiled mosaic M wherein each pi-con P1-PX substantively fills the display area of a tile T1-TX of the mosaic M, or other suitable selection presentation schema known in the art.

In step A.8 the client system determines whether the user had issued a back command by pressing the return navigation 8B button, and if so, the client system returns to step A.1 and actualizes the first state I. If a back command is not detected by the client system 2 in step A.8, the client system 2 proceeds on to step A.9 of FIG. 10B.

The user may page through the pi-cons P1-PX presented in step A.7 by means of the navigation buttons 8R, 8L, 8U & 8D, whereby the focus is shifted from one pi-con to a neighboring pi-con P1-PX and the focus register FR of the table is updated at each instance that the client system 2 detects a shift focus command sent via the navigation buttons 8R, 8L, 8U & 8D.

In step A.9 the client system determines whether a select command has been issued by the user's depressing the select button 8S. When a select command is received by the client system 2 in step A.10, the client system 2 proceeds on to step A.11 and actualizes the third state III, wherein information describing the document D1-DX selected in step A.9 is rendered onto the display screen 4. The user may then direct the client system to render the document D1-DX associated with the information displayed in step A.10 by depressing the select button 8S in during step A.11

Alternatively, the user may direct the client system 2 to power down turn off the in steps A.14 and A.15, or shift focus in steps A.16 and A.17.

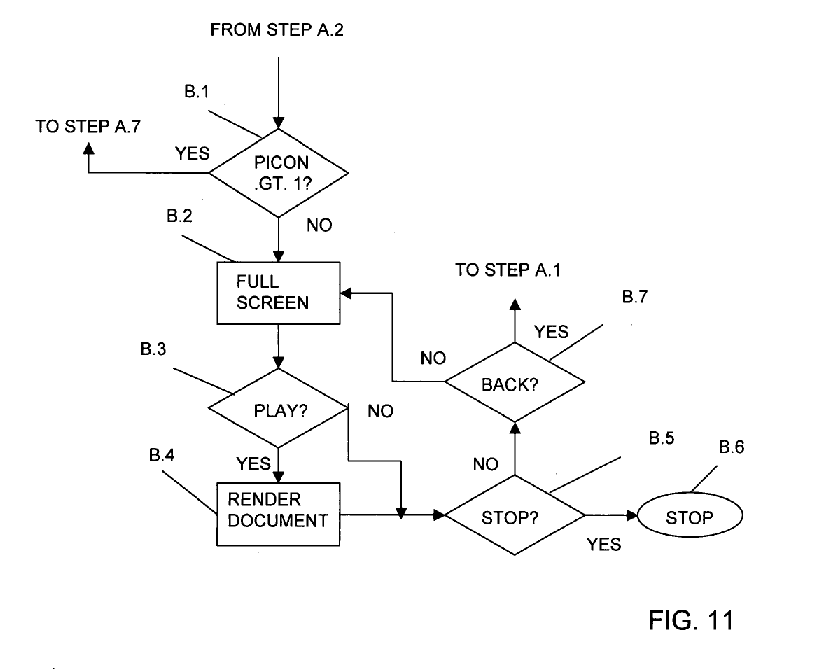

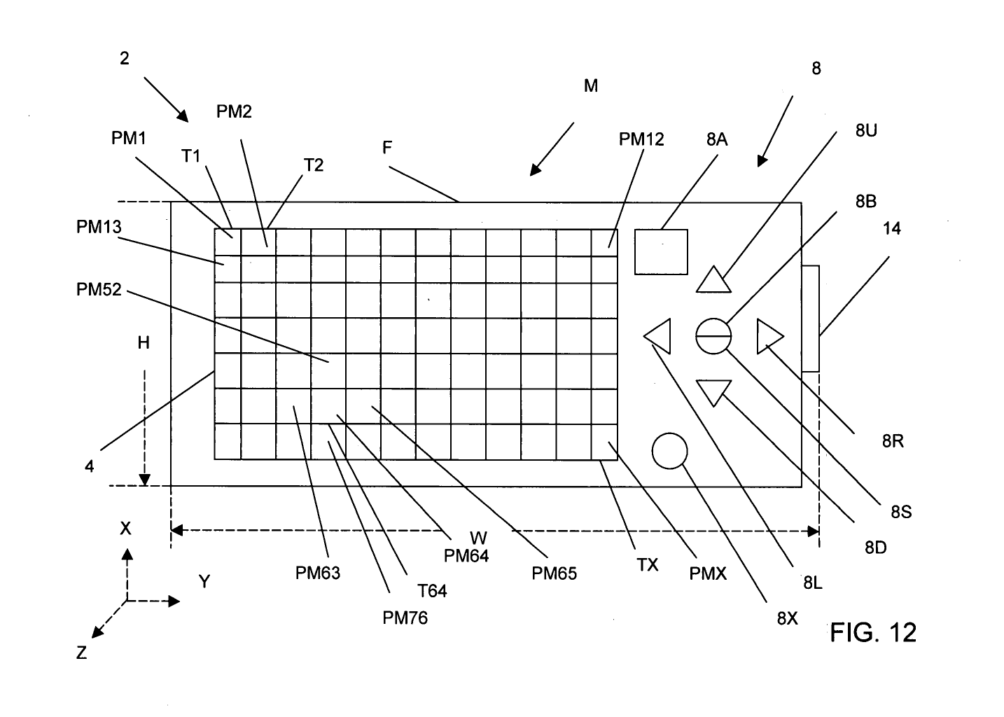

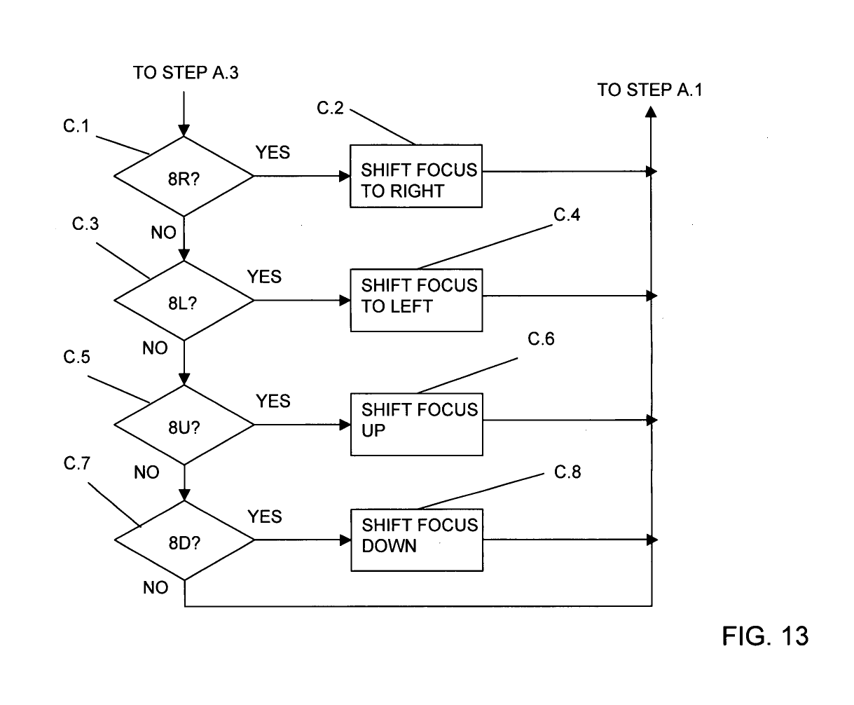

Referring now generally to the Figures and particularly to FIG. 11, FIG. 11 is a flowchart of an optional or additional process of the flowchart of FIGS. 10A and 10B. The process described in FIG. 11 applies when a category of pi-cons P1-PX, e.g., music, video, animation or photographic, as stored in data structure S of the client system 2 comprises only one document D1-DX. In such cases, the client system may proceed from step B.1 to actualize the third state III and display information associated with the instant one document D1-DX in the display screen 4 and without actualizing the largely redundant and intermediate second state II. The client system 2, when directed by the user, will proceed on from step B.3 to B.4 to render the instant document D1-DX and actualize the fourth state IV. Alternatively, the user may direct the client system 2 to return from step B.7 to step A.1, and thereupon to actualize the first state I.

Referring now generally to the Figures and particularly FIG. 12, FIG. 12 is an illustration of the client system 2 actualizing the second state II, wherein the plurality of music document pi-cons PM1-PMX are displayed within the mosaic M of tiles T1-TX. A unique pi-con P1-PX is displayed separately in one tile T1-TX. The tiles T1-TX are organized along an up and down axis parallel to the H axis of the display screen 4, and along a left to right axis parallel to the W axis of the display screen 4. Focus is shifted within the mosaic M and from one pi-con PM1-PMX by pressing the navigation buttons 8R, 8L, 8U & 8D. The records R1-RX contains pointers or addresses to documents D1-DX that enable the mosaic M to be actualized as a two dimensional linked list, wherein each pi-con P1-PX included in the mosaic M is linked with (1.) a rightward ordered pi-con in the next record data field RR, (2.) a leftward ordered pi-con in the previous record data field RP, (3.) an upwards ordered pi-con in the up address data field RU, and (4.) a downward ordered pi-con in the down address data field RB. Rightward is determined as the direction along the W axis and closer to the user control buttons 8. Leftward is determined as the direction along the W axis and away from the user control buttons 8. Upwards is determined as the direction along the H axis and closer to the document accept button 8A. Downwards is determined as the direction along the H axis and closer to the document delete button 8X.

Referring now generally to the Figures and particularly to FIG. 13, FIG. 13 is a flowchart of a partial operation of the GUI 16 that may be actualized between steps A.3 and A.1 of FIG. 10A in certain even additional alternate preferred embodiments of the Method of the Present Invention. Taking as an example where the focus is on the 64^{th} music pi-con PM64 that is displayed in the 64^{th} tile T64, the user may shift the focus to (1.) the 65th music pi-con PM65 by depressing the right navigation button 8R in coincident with the execution of step C.1, (2.) the 63rd music pi-con PM63 by depressing the left navigation 8L in coincident with the execution of step C.3, (3.) the 52nd music pi-con PM52 by depressing the up navigation 8U in coincident with the execution of step C.5, or (4.) the 76th music pi-con PM76 by depressing the left navigation 8L in coincident with the execution of step C.3. This is enabled by the record R1-RX that comprises the 64th music pi-con PM64 also includes a pointer to or memory address of (1.) a 65th music document DM65 associated with the 65th music pi-con PM65 in a next document data field RR; (2.) a 63rd music document DM63 associated with the 63rd music pi-con PM63 in a previous document data field RL; (3.) a 52nd music document DM52 associated with the 52nd music pi-con PM52 in an up address document data field RU; and (4.) a 76th music document DM76 associated with the 76th music pi-con PM76 in a down address document data field RB.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. Such changes and modifications are included within the scope and spirit of the present disclosure as set forth in the appended claims.

I claim:

1. In a digital media player, the digital media player having a memory device storing a plurality of electronic documents, a video screen for displaying a presentation of the plurality of electronic documents, a user interface method, the user interface method comprising:
associating a first electronic documents with a first pi-con, wherein the first pi-con comprises a representation of a physical product associated with the first electronic document;
associating a second electronic document with a second pi-con;
presenting at least the first and second pi-cons to the user by means of the video screen; and
enabling the user to select at least one pi-con, wherein an electronic document associated with the selected pi-con is subsequently rendered by the digital media player.

2. The method of claim 1, wherein the digital media player is bi-directionally coupled with a streaming media source, and the method further comprises enabling the user to select a pi-con associated with a streamed electronic document, and the streamed electronic document is rendered by means of the digital memory device when selected by the user.

3. The method of claim 1, wherein a first pi-con is presented in a first window, and the user may, and the user may select the first pi-con, wherein a first plurality of pi-cons associated with documents is subsequently rendered by the digital media player.

4. The method of claim 3, wherein the user may select one pi-con from the first plurality of pi-cons and direct the digital media player to render an electronic document associated with said selected pi-con.

5. The method of claim 4, wherein at least one pi-con of the plurality of pi-cons is associated with an electronic document selected from the group consisting of a digitized photographic data document, a digitized video data document, a digitized animation data document, and a digitized audio data document.

6. The method of claim 3, wherein a second pi-con is presented in a second window contemporaneously with the presentation of the first pi-con, and the user may select the second pi-con, wherein a second plurality of pi-cons associated with documents is subsequently rendered by the digital media player.

7. The method of claim 6, wherein the user may select one secondary pi-con from the second plurality of pi-cons and direct the digital media player to render an electronic document associated with said selected pi-con.

8. The method of claim 7, wherein at least one pi-con of the second plurality of pi-cons is associated with an electronic document selected from the group consisting of a digitized photographic data document, a digitized video data document, a digitized animation data document, and a digitized audio data document.

9. The method of claim 6, wherein a third pi-con is presented in a third window contemporaneously with the presentation of the first pi-con and second pi-con, and the user may select the third pi-con, wherein a third plurality of pi-cons associated with documents is subsequently rendered by the digital media player.

10. The method of claim 1, wherein the at least one pi-con substantively models the aspect ratio of one view of the physical product.

11. A graphical user interface (“GUI”) comprising:
a first region for displaying a first image associated with a first electronic document of a first plurality of electronic documents, wherein the first image substantively represents a view of a product associated with an electronic document; and
a second region for displaying a second image associated with a second plurality of electronic documents, wherein a user may select the first image to render the first electronic document, or the second image to explore the second plurality of electronic documents.

12. The GUI of claim 11, wherein the first plurality of electronic documents comprises electronic media documents selected from the group consisting of animation data documents, video data documents, audio data documents and photographic data documents.

13. The GUI of claim 11, wherein the second plurality of electronic documents comprises electronic media documents selected from the group of consisting of animation data documents, video data documents, audio data documents and photographic data documents.

14. The GUI of claim 11, further comprising a third region for rendering a third image, the third image associated with a third electronic document of a third plurality of electronic documents.

15. The GUI of claim 11, wherein the third plurality of electronic documents comprises electronic media documents selected from the group of consisting of animation data documents, video data documents, audio data documents and photographic data documents.

16. An article of manufacture including a sequence of instructions which, when executed by a processor, causes said processor to generate a GUI comprising:
a first region for displaying a first image associated with a product, the product including a first electronic document of a first plurality of electronic documents; and
a second region for displaying a second image associated with a second electronic document of a second plurality of electronic documents, wherein a user may select the first image to render the first electronic document, or the second image to explore the second plurality of electronic documents.

17. A computer-readable media including a sequence of computer-readable instructions which, when executed by a processor, causes said processor to generate a GUI comprising:
a first region for displaying an first image associated with a product including a first electronic document of a first plurality of electronic documents; and a second region for displaying a second image associated with a second electronic document of a second plurality of electronic documents, wherein a user may select the first image to render the first electronic document, or the second image to explore the second plurality of electronic documents.

18. A hand-held device, the device comprising:
a central processing unit coupled with a video display and a memory unit, wherein the central processing unit renders to the video display a plurality of electronic documents; and
means to render a GUI, the GUI comprising a plurality of images on the video display, each of the images representing one of said electronic documents, the GUI providing:
a first region of the GUI displaying a first image associated with a first electronic document of a first plurality of electronic documents, the first image visually representing a view of a product associated with the first image;
a second region of the GUI displaying a second image associated with a second plurality of electronic documents, wherein a user may select the first image to render the first electronic document, or the second image to explore the second plurality of electronic documents.
